(19) United States
(12) Patent Application Publication
(10) Pub. No.: US 2026/0066745 A1
(43) Pub. Date: Mar. 5, 2026

(54) ROTOR, EXTERNALLY EXCITED SYNCHRONOUS MACHINE AND MOTOR VEHICLE

(71) Applicant: AUDI AG, Ingolstadt (DE)

(72) Inventor: Daniel RUPPERT, Lenting (DE)

(21) Appl. No.: 19/312,092

(22) Filed: Aug. 27, 2025

(30) Foreign Application Priority Data
Aug. 28, 2024 (DE) 102024124571.9

(51) Int. Cl. H02K 11/042; H02K 7/00; H02K 11/00; H02K 11/33; H02K 19/02

(52) U.S. Cl. CPC H02K 11/042; H02K 7/006; H02K 11/0094; H02K 11/33; H02K 19/02; H02K 2213/06

(57) ABSTRACT

A rotor for an externally excited synchronous machine is disclosed, and may include a rotor winding, a power converter circuit. and a secondary coil. The power converter circuit may include a first secondary coil contact, a second secondary coil contact, a first rotor winding contact, and a second rotor winding contact. The power converter circuit may be configured, in a first operating mode, to convert an alternating voltage induced in the secondary coil into a direct voltage and to apply the direct voltage to the rotor winding via rotor winding terminals. The first secondary coil contact and the second secondary coil contact may each be connected via a first line branch of at least one first line branch to the first rotor winding contact and via a second line branch of at least one second line branch to the second rotor winding contact.

### BACKGROUND

### Technical Field

The present disclosure relates to a rotor for an externally excited synchronous machine, specifically a rotor configured to convert an alternating voltage induced in a coil into a direct voltage to be applied to a rotor winding

### Description of the Related Art

In contrast to permanently excited synchronous machines, externally excited synchronous machines do not require any magnetic materials in the rotor and generate the rotor magnetic field by energizing a rotor winding. This results in additional degrees of freedom in the control and design of the electric machine, which may lead to increased efficiency and performance. This may be particularly relevant if the electric machine is to be utilized to drive a motor vehicle, as in this case, high performance must be achieved with low weight and space requirements.

According to the current prior art, the rotor winding is energized either via slip ring contacts or contactlessly via a power transfer system with an inductive rotary transformer. In the latter case, a stator-side inverter, an inductive rotary transformer comprising a stator-side primary coil and a rotor-side secondary coil, a rotor-side rectifier, and, optionally, a filter for smoothing the excitation current are typically used to energize the rotor winding.

For reasons of efficiency, it is often expedient to set a high rotor magnetic field by way of high excitation currents, since with an increasing rotor magnetic field, lower alternating currents are required in the stator coils to achieve the same torques of the synchronous machine.

Due to the typically high inductance of the rotor winding and the preferably high excitation current utilized, high amounts of energy are present in the rotor during operation. It is therefore expedient to implement a “quick de-excitation” of the rotor winding in certain operating situations, such as, for example, in the event of an accident, in which case, however, additional rotor-side circuitry for energy dissipation is required.

### BRIEF SUMMARY

The present disclosure provides an improved externally excited synchronous machine or an improved rotor for such a synchronous machine, in particular with respect to a targeted reduction of the rotor magnetic field.

The present disclosure provides a rotor for an externally excited synchronous machine, comprising a rotor winding, a power converter circuit and a secondary coil. The power converter circuit comprises a first and a second secondary coil contact, which are electrically connected to the secondary coil, and a first and a second rotor winding contact that are electrically connected to the rotor winding. The rotor is configured, in a first operating mode, to convert an alternating voltage induced in the secondary coil and supplied via the secondary coil terminals into a direct voltage in order to apply this direct voltage to the rotor winding via the rotor winding terminals to establish and/or maintain the rotor magnetic field, wherein the first and the second secondary coil contact are each connected to the first rotor winding contact via a first line branch and to the second rotor winding contact via a second line branch,, wherein each of the respective first and the respective second line branch may comprise first and a second switching devices which may be connected in series with one another between the respective secondary coil contact and the respective rotor winding contact. The respective switching devices may have a semiconductor switch which comprises an intrinsic diode and/or to which a diode is connected in parallel, wherein the diode of the first switching device and the diode of the second switching device of the respective line branch have mutually opposite forward directions.

If both semiconductor switches of a line branch are in a blocking state, current flow through the line branch may be prevented for both possible current flow directions. If both semiconductor switches are in a conducting state, however, current flow through the conduction path may be possible in both current flow directions, particularly with low resistance. In switching states in which only one of the semiconductor switches of the respective conduction path is in the blocking state, the diode connected in parallel or intrinsic thereto may enable current flow through the line branch exclusively in the forward direction of this diode.

The embodiments provided in the present disclosure not only enable the power converter circuit to be utilized to receive energy for establishing the rotor magnetic field via the secondary coil in the first operating mode, but also to be utilized in a second operating mode to actively reduce the rotor magnetic field of the rotor winding and to emit the energy extracted from the rotor magnetic field via the secondary coil or transfer the energy extracted from the rotor magnetic field to the stator-side primary coil. Such embodiments may enable, on the one hand, a rapid reduction of the rotor magnetic field and thus a rapid reduction in the current flowing through the rotor winding, which may be expedient, for example, in accident situations, without the need for a special rotor-side protective circuit, such as a clamping network. On the other hand, the feedback of energy to a stator-side primary coil may enable recuperation of the energy utilized to establish the rotor magnetic field, thereby increasing the efficiency of a synchronous machine comprising this rotor.

In conventional active rectifiers for providing current to a rotor winding, in contrast to embodiments of the disclosure, only a single semiconductor switch with an intrinsic or parallel-connected diode is utilized in the respective line branch. When a potential is applied to the rotor winding to establish or maintain the rotor magnetic field, this diode is subjected to a reverse voltage. If active field reduction is to occur in such a configuration, in order to achieve particularly rapid field reduction and/or recuperation, the rotor winding and thus also the diode would have to be subjected to voltage in the opposite direction. However, when the freewheeling voltage of the diode is reached, the voltage transports current with low resistance, so that for active field reduction when utilizing a customary rotor-side power converter, only very low voltages below this freewheeling voltage can be utilized to actively reduce the current through the rotor winding.

This problem is avoided by inventive utilization of semiconductor switches connected in series and having parallel-connected or intrinsic diodes with opposite forward direction, since in embodiments of the present disclosure, a forward direction or freewheeling current for the individual current directions may be controlled separately.

The electrical connection of the secondary coil terminals to the secondary coil and the rotor winding terminals to the rotor winding may be made directly or via other electrical components. For example, the rotor winding terminals may additionally be connected via a buffer capacitor to reduce ripple of the direct voltage applied to the rotor winding.

The respective semiconductor switch may be a metal oxide semiconductor field effect transistor (“MOSFET”), which comprises the intrinsic diode. A MOSFET is a transistor with an insulated gate and therefore, may be well suited for switching high currents or voltages. The presence of an intrinsic diode may eliminate the need for a separate freewheeling diode, and voltage spikes may not occur when switching high coil currents. MOSFETs may also enable short switching times, thus minimizing switching losses, which is particularly relevant in power converters, which typically require high-frequency switching of the semiconductor switches.

Furthermore, the present disclosure relates to an externally excited synchronous machine comprising the rotor according to the present disclosure, wherein the rotor may be rotatably mounted on a stator and the synchronous machine may comprise an energizing device, which is configured to apply an alternating current to a primary coil of the stator. The alternating voltage may be induced in the secondary coil of the rotor.

The energization device may be an inverter which is fed by a direct voltage source, for example a battery, which, in some embodiments, may be arranged outside the synchronous machine, for example in a motor vehicle comprising the synchronous machine.

A respective pair of one of the first line branches and one of the second line branches may form a respective half bridge between the first and the second rotor winding contact, wherein the forward direction of the diodes of the first switching device in the respective half bridge are directed from the second rotor winding contact to the first rotor winding contact. The synchronous machine may comprise a control device which is configured, in the first operating mode, to switch the semiconductor switches of all second switching devices into a continuously conductive state and to switch the semiconductor switches of the first switching device into an intermittently conductive state in order to rectify the alternating voltage supplied via the secondary coil terminals. In the first operating mode, switching into an intermittently conductive state is understood to mean switching alternating into a conductive and a blocking state, such as with a periodic switching pattern.

Since the forward directions of the first and the second switching devices are opposite to one another, the forward directions of the diodes of the second switching device in the respective half bridge may be, in the first operating mode, directed from the first to the second rotor winding contact.

In the first operating mode, the power converter circuit may thus provide a more positive potential at the first rotor winding contact than the potential at the second rotor winding contact, so that the current flow through the rotor winding from the first rotor winding contact to the second rotor winding contact may be increased or line losses may be compensated. The direction of current flow described throughout the present disclosure is considered to be the technical current direction.

Additionally, the control device may be configured to switch the semiconductor switches of all first switching devices into the continuously conductive state in a second operating mode and to switch the semiconductor switches of the second switching devices into the intermittently conductive state in order to convert at least part of a direct current conducted through the rotor winding from the first rotor winding contact to the second rotor winding contact into an alternating current supplied to the secondary coil in order to conduct energy from the rotor winding via the secondary coil and the primary coil to the energization device or another component of the externally excited synchronous machine.

During energy transfer from the rotor winding back to the stator, the current flowing through the rotor winding may be actively reduced, in which case the potential at the second rotor winding contact, based on the current flow caused or maintained by the first operating mode, may be more positive than the potential at the first rotor winding contact. Since those diodes connected in parallel with the semiconductor switches switched into the intermittent state in the second operating mode block a current flow with the technical current flow direction from the second rotor winding contact to the first rotor winding contact through the respective half bridge when these semiconductors are switched off, the inverter circuit utilized may provide high counter potentials and thus the current in the rotor winding may be quickly reduced or recuperated.

The present disclosure also relates to a motor vehicle comprising an externally excited synchronous machine according to the present disclosure. As already explained above, high power densities for electric machines in motor vehicles are often desirable to be achieved, which may cause the additional degrees of freedom in machine design provided by the utilization of an externally excited synchronous machine particularly advantageous. Since high rotor magnetic field strengths may also be advantageous in such motor vehicles, the rapid reduction of rotor winding currents made possible by the inventive configuration of the rotor or the synchronous machine is particularly relevant.

In at least one operating state of the motor vehicle, the synchronous machine may be mechanically coupled to at least one wheel of the motor vehicle such that the synchronous machine drives the wheel as a drive motor. In such embodiments, the respective wheel may be permanently coupled to the synchronous machine, for example, in the case of a single-wheel drive. However, in other embodiments, the synchronous machine may drive multiple wheels of the motor vehicle via a transmission and/or a differential, or may be decoupled from said wheels.

The motor vehicle may comprise a direct voltage on-board network, wherein the control device may be configured to operate the energization device configured as a further power converter as an inverter in the first operating mode in order to inductively transfer energy to the rotor, and to operate the energization device as a rectifier in the second operating mode in which the rotor magnetic field of the rotor winding is actively reduced in order to rectify an alternating voltage induced in the primary coil and thereby feed energy into the direct voltage on-board network.

In some embodiments, in the second operating mode, the energy recovered during the reduction of the rotor magnetic field may be used to charge a battery in the direct voltage on-board network and/or to operate another component arranged therein.

In some embodiments, the control device may control the rotor-side power converter circuit or semiconductor switches of the rotor-side power converter circuit in the second operating mode, as explained above, to actively reduce the rotor current. If the control device is part of the stator or generally arranged outside the rotor, control signals for the rotor-side power converter circuit may be transferred inductively. The semiconductor switches of the rotor-side power converter circuit and/or semiconductor switches of the stator-side power converter may be controlled via a galvanically isolating gate driver.

The control device may be configured to switch from the first to the second operating mode upon meeting of a triggering condition in order to actively reduce the rotor magnetic field generated by the rotor winding. In some embodiments, meeting the triggering condition may depend on whether there is an accident and/or a shutdown process of the synchronous machine.

An accident may be detected, for example, by collision sensors or when a distance falls below a limit values, as determined by distance sensors. A signal indicating an accident may also be provided by other vehicle systems, for example, by safety systems such as an airbag control system, a belt tensioner, or similar. In the event of an accident, components that potentially carry high voltages should be quickly de-energized. For coils with high inductance, such as, for example, the rotor winding, active de-energization of the coil is expedient for this purpose, as is made possible by the inventive configuration of the rotor or the synchronous machine or the motor vehicle.

When the synchronous machine is switched off, the rotor magnetic field may be reduced to zero, which is why active coil current reduction, especially in conjunction with recuperation of the energy of the rotor magnetic field, is particularly expedient in this case.

### BRIEF DESCRIPTION OF THE SEVERAL VIEWS OF THE DRAWINGS

FIG. 1 shows a schematic view of an exemplary embodiment of a motor vehicle according to the present disclosure, which comprises an exemplary embodiment of a synchronous machine according to the present disclosure, which in turn comprises an exemplary embodiment of a rotor according to the present disclosure.

FIG. 2 shows a schematic view of the power converter circuit utilized in the rotor of FIG. 1.

### DETAILED DESCRIPTION

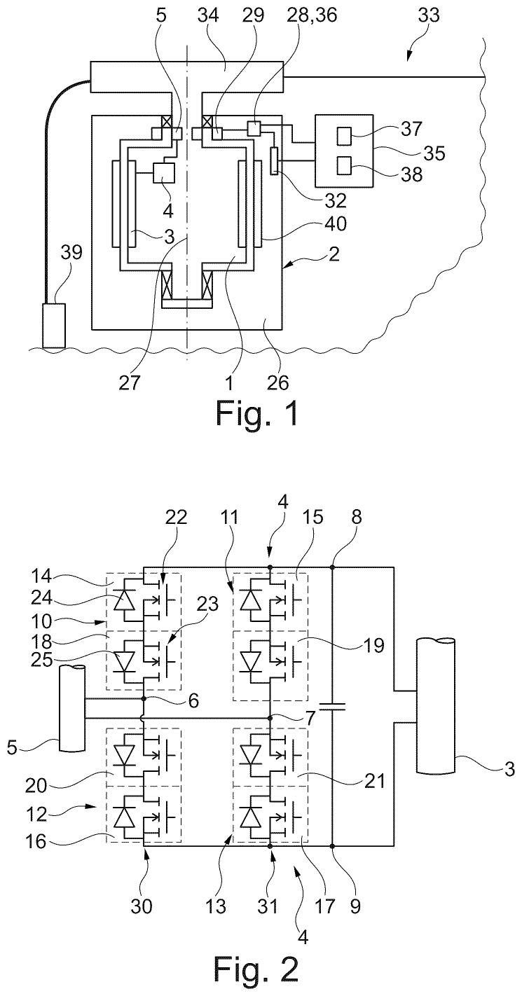

FIG. 1 shows a schematic view of a motor vehicle 33, illustrating one of the wheels 34 of motor vehicle 33 and an externally excited synchronous machine 2 associated with wheel 34 as a drive motor. The direct coupling of rotor 1 of synchronous machine 2 to wheel 34 shown is purely exemplary. Alternatively, synchronous machine 2 could drive wheel 34 or a plurality of wheels, for example via a transmission and/or a differential.

Synchronous machine 2 may be powered by a direct voltage on-board network 35 of motor vehicle 33, which may comprise a battery 37 and further direct voltage components 38. For clarity, FIG. 1 only illustrates a part of the motor electronics that is used to supply current to rotor winding 3. The intermittent energization of stator coils 40 for applying torque to the rotor about axis of rotation 27 may be provided, for example, by stator-side power converter 36 or a separate power converter (not shown).

In a first operating mode of synchronous machine 2, energy may be transferred contactlessly from stator 26 to rotor 1 in order to increase the rotor magnetic field by increasing the current conducted through rotor winding 3 or to compensate for line losses and thus maintain the current through rotor winding 3.

For this purpose, stator-side primary coil 29 may be supplied with an alternating current by energization device 28. In the example shown in FIG. 1, energization device 28 is formed by a power converter 36, the power converter 36 or semiconductor switches (not shown) of the power converter 36, may be controlled by control device 32 in the first operating mode to operate power converter 36 as an inverter which inverts the direct current provided by direct voltage on-board network 35. Such a configuration may result in an alternating current in primary coil 29, which produces an alternating electromagnetic field in the area of secondary coil 5, thereby inducing an alternating voltage in secondary coil 5.

Then, in the first operating mode, a rotor-side power converter circuit 4 may be utilized to rectify the induced alternating voltage and thus to apply a direct voltage to rotor coil 3 and thus increase or maintain the current flowing through rotor coil 3. The corresponding control of rotor-side power converter circuit 4 may also occur by way of control device 32. For this purpose, in particular, control signals of control device 32 may be transferred to rotor 1 contactlessly, for example via a further pair (not shown) consisting of a primary and a secondary coil. Alternatively, for example, a separate rotor-side control device may also be provided, or the control signals may be transferred via at least one slip ring.

By operating rotor-side power converter circuit 4 in a second operating mode, which is explained in detail below with reference to FIG. 2, this power converter circuit 4 may also be utilized to actively reduce the rotor magnetic field of rotor winding 3 and to feed the energy recovered in this way back to energization device 28 and via this energization device 28 into direct voltage on-board network 35. Thus, the recovered energy may, for example, be used to charge battery 37 or to operate another direct voltage component 38 in direct voltage on-board network 35. In such embodiments, stator-side power converter 36 may be operated as a rectifier to rectify the alternating voltage induced by the inductive energy transfer in primary coil 29.

FIG. 2 illustrates a schematic view of rotor-side power converter circuit 4. Power converter circuit 4 may be electrically connected to secondary coil 5 via a first and a second secondary coil contact 6, 7 and to rotor winding 3 via a first and a second rotor winding contact 8, 9. The first and the second secondary coil contacts 6, 7 may each be connected to first rotor winding contact 8 via a first line branch 10, 11 and to second rotor winding contact 9 via a second line branch 12, 13.

In order to enable, on the one hand, an increase or maintenance of the current conducted through rotor winding 3 and, on the other hand, an active reduction of this current and thus an active field reduction of the rotor magnetic field, power converter circuit 4 may be configured to provide direct voltages with different polarities to rotor winding contacts 8, 9 in the first and in the second operating modes. In such embodiments, in the first operating mode, in order to establish or maintain the rotor magnetic field, a higher potential may be applied to first rotor winding contact 8 than to second rotor winding contact 9. In the second operating mode, however, the potential at second rotor winding contact 9 may be higher than the potential at first rotor winding contact 8 in order to provide a counter voltage for field reduction.

To enable such operation, line branches 10, 11, 12, 13 may each comprise first and second switching devices 14, 15, 16, 17, 18, 19, 20, 21, which are connected in series with one another between respective secondary coil contact 6, 7 and respective rotor winding contact 8, 9. Respective switching devices 14, 15, 16, 17, 18, 19, 20, 21 may have a semiconductor switch 22, 23, to which a respective diode 24, 25 is connected in parallel. In order to enable selective blocking of the current flow in both current flow directions through respective line branches 10, 11, 12, 13 or through respective half bridges 30, 31 formed by two of line branches 10, 11, 12, 13 by suitable switching of semiconductor switches 22, 23, respective diode 24 of respective first switching device 14, 15, 16, 17 may have a forward direction that is opposite to the forward direction of respective diode 25 of respective second switching device 18, 19, 20, 21.

In the example embodiment shown in FIG. 2, diodes 24, 25 are formed separately from respective semiconductor switches 22, 23 for purposes of clarity. However, it may be advantageous to use semiconductor switches with an intrinsic diode instead, since in this case, a separate, parallel-connected diode is not necessarily required. In some embodiments, respective semiconductor switch 22, 23 may be a MOSFET which comprises respective diode 24, 25 as intrinsic diode 24, 25.

In the first operating mode, control device 32 may switch semiconductor switches 23 of all second switching devices 18, 19, 20, 21 into a continuously conductive state and switch semiconductor switches 22 of first switching devices 14, 15, 16, 17 into an intermittently conductive state in order to rectify the alternating voltage supplied via secondary coil terminals 6, 7. Thus, in the first operating mode, substantially the same function may result as that provided by known rotor-side active rectifiers, which have only a single semiconductor switch per line branch.

In the second operating mode, however, the control device may switch semiconductor switches 22 of all first switching devices 14, 15, 16, 17 into a continuously conductive state and switch semiconductor switches 23 of second switching devices 18, 19, 20, 21 into an intermittently conductive state in order to convert at least part of a direct current conducted through rotor winding 3 from first rotor winding contact 8 to second rotor winding contact 9 into an alternating current supplied to secondary coil 5. Since diodes 25 of the semiconductor switches 23, which may be in the intermittent state in the second operating mode, may block a current flow from second rotor winding contact 9 to first rotor winding contact 8 via half bridge 30, 31 in the respective half bridge, the current direction in the second operating mode may be such that the potential at second rotor winding contact 9 is more positive than the potential at first rotor winding contact 8, thereby reducing a current flow from first rotor winding contact 8 to second rotor winding contact 9 through rotor winding 3, which current flow generates the rotor magnetic field. As a result, energy may be conducted from rotor winding 3 via secondary coil 5 and primary coil 29 to and, via this energization device 28, into the direct voltage network 35.

In the example embodiment shown in the figures, during normal driving operation of motor vehicle 33, synchronous machine 2 may be operated in the first operating mode in order to establish or maintain the rotor magnetic field and thus enable torque to be provided by synchronous machine 2. Switching to the second operating mode may only occur when a triggering condition is met.

In the example embodiment shown in the figures, the triggering condition may be met, on the one hand, when synchronous machine 2 is deactivated, for example, when the motor vehicle is parked or when no drive torque is expected to be required for an extended period of time. On the other hand, the triggering condition may be met when an accident involving motor vehicle 33 is detected, for example, by way of a collision sensor 39, or when other safety systems trigger an airbag and/or a belt tensioner, for example.

The triggering condition may also be met, for example, when the synchronous machine 2 switches from a high-performance mode to a mode in which the synchronous machine 2 provides lower power, for example for operation of motor vehicle 33 in an economy mode or in the case of a low battery state of charge 37.

German patent application no. 102024124571.9, filed Aug. 28, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A rotor for an externally excited synchronous machine, comprising:
a rotor winding;
a secondary coil; and
a power converter circuit comprising a first secondary coil contact, a second secondary coil contact, a first rotor winding contact, and a second rotor winding contact, the first secondary coil contact and the second secondary coil contact each electrically connected to the secondary coil, the first rotor winding contact and the second rotor winding contact each electrically connected to the rotor winding, the power converter circuit configured, in a first operating mode, to convert an alternating voltage induced in the secondary coil and supplied via secondary coil terminals into a direct voltage and to apply the direct voltage to the rotor winding via rotor winding terminals such that a rotor magnetic field is established and/or maintained,
wherein the first secondary coil contact and the second secondary coil contact are each connected to the first rotor winding contact via a first line branch of at least one first line branch and to the second rotor winding contact via a second line branch of at least one second line branch,
wherein each first line branch and each second line branch includes a first switching device and a second switching device, each first switching device and second switching device are connected in series with one another between one secondary coil contact of the first and second secondary coil contacts and one rotor winding contact of the first and second rotor winding contacts,
wherein each of the first switching devices and the second switching devices includes a semiconductor switch, each semiconductor switch including an intrinsic diode and/or is connected in parallel to a diode, and
wherein the intrinsic diode of the first switching device and/or the diode connected in parallel to the first switching device and the intrinsic diode of the second switching device and/or the diode connected in parallel to the second switching device of a respective line branch of the first and second line branches have mutually opposite forward directions.

2. The rotor according to claim 1, wherein each semiconductor switch is a MOSFET including the respective intrinsic diode.

3. An externally excited synchronous machine, comprising:
a rotor including:
a rotor winding;
a secondary coil; and
a power converter circuit comprising a first secondary coil contact, a second secondary coil contact, a first rotor winding contact, and a second rotor winding contact, the first secondary coil contact and the second secondary coil contact each electrically connected to the secondary coil, the first rotor winding contact and the second rotor winding contact each electrically connected to the rotor winding, the power converter circuit configured, in a first operating mode, to convert an alternating voltage induced in the secondary coil and supplied via secondary coil terminals into a direct voltage and to apply the direct voltage to the rotor winding via rotor winding terminals such that a rotor magnetic field is established and/or maintained,
wherein the first secondary coil contact and the second secondary coil contact are each connected to the first rotor winding contact via a first line branch of at least one first line branch and to the second rotor winding contact via a second line branch of at least one second line branch,
wherein each first line branch and each second line branch includes a first switching device and a second switching device, each first switching device and a respective second switching device are connected in series with one another between one secondary coil contact of the first and second secondary coil contacts and one rotor winding contact of the first and second rotor winding contacts,
wherein each of the first and second switching devices includes a semiconductor switch, each semiconductor switch including an intrinsic diode and/or is connected in parallel to a diode, and
wherein the intrinsic diode of the first switching device and/or the diode connected in parallel to the first switching device and the intrinsic diode of the second switching device and/or the diode connected in parallel to the second switching device of a respective line branch of the first and second line branches have mutually opposite forward directions;
a stator on which the rotor is rotatably mounted; and
an energizing device configured to apply an alternating current to a primary coil of the stator, whereby the alternating voltage is induced in the secondary coil of the rotor.

4. The externally excited synchronous machine according to claim 3, wherein a pair of line branches including a first line branch of the at least one first line branches and a second line branch of the at least one second line branches forms a half bridge between the first and the second rotor winding contact,
wherein the forward direction of the intrinsic diode of the first switching device and/or the diode connected in parallel to the first switching device in the half bridge is directed from the second rotor winding contact to the first rotor winding contact, and
wherein the externally excited synchronous machine further comprises a control device configured, in a first operating mode, to switch the semiconductor switches of each second switching device into a continuously conductive state and to switch the semiconductor switches of each first switching device into an intermittently conductive state, such that the alternating voltage supplied via the secondary coil terminals is rectified.

5. The externally excited synchronous machine according to claim 4, wherein the control device is configured, in a second operating mode, to switch the semiconductor switches of each first switching device into a continuously conductive state and to switch the semiconductor switches of each second switching device into an intermittently conductive state, such that at least part of a direct current conducted through the rotor winding from the first rotor winding contact to the second rotor winding contact is converted into an alternating current supplied to the secondary coil, and such that energy from the rotor winding is conducted via the secondary coil and the primary coil to the energization device.

6. The externally excited synchronous machine according to claim 4, wherein the control device is configured, in a second operating mode, to switch the semiconductor switches of each first switching device into a continuously conductive state and to switch the semiconductor switches of each second switching device into an intermittently conductive state, such that at least part of a direct current conducted through the rotor winding from the first rotor winding contact to the second rotor winding contact is converted into an alternating current supplied to the secondary coil, and such that energy from the rotor winding is conducted via the secondary coil and the primary coil to another component of the externally excited synchronous machine.

7. A motor vehicle comprising:
an externally excited synchronous machine including:
a rotor including:
a rotor winding;
a secondary coil; and
a power converter circuit comprising a first secondary coil contact, a second secondary coil contact, a first rotor winding contact, and a second rotor winding contact, the first secondary coil contact and the second secondary coil contact each electrically connected to the secondary coil, the first rotor winding contact and the second rotor winding contact each electrically connected to the rotor winding, the power converter circuit configured, in a first operating mode, to convert an alternating voltage induced in the secondary coil and supplied via secondary coil terminals into a direct voltage and to apply the direct voltage to the rotor winding via rotor winding terminals such that a rotor magnetic field is established and/or maintained,
wherein the first secondary coil contact and the second secondary coil contact are each connected to the first rotor winding contact via a first line branch of at least one first line branch and to the second rotor winding contact via a second line branch of at least one second line branch,
wherein each first line branch and each second line branch includes a first switching device and a second switching device, each first switching device and a respective second switching device are connected in series with one another between one secondary coil contact of the first and second secondary coil contacts and one rotor winding contact of the first and second rotor winding contacts,
wherein each of the first and second switching devices includes a semiconductor switch, each semiconductor switch including an intrinsic diode and/or is connected in parallel to a diode, and
wherein the intrinsic diode of the first switching device and/or the diode connected in parallel to the first switching device and the intrinsic diode of the second switching device and/or the diode connected in parallel to the second switching device of a respective line branch of the first and second line branches have mutually opposite forward directions;
a stator on which the rotor is rotatably mounted; and
an energizing device configured to apply an alternating current to a primary coil of the stator, whereby the alternating voltage is induced in the secondary coil of the rotor.

8. A motor vehicle according to claim 7, wherein the externally excited synchronous machine is mechanically coupled to at least one wheel of the motor vehicle in at least one operating state of the motor vehicle such that the externally excited synchronous machine drives the wheel as a drive motor.

9. The motor vehicle according to claim 7, further comprising a direct voltage on-board network,
wherein the energizing device is configured as a power converter, and
wherein a control device is configured to operate the energizing device as an inverter in a first operating mode such that energy is inductively transferred to the rotor, and to operate the energizing device as a rectifier in a second operating mode, such that an alternating voltage induced in the primary coil is rectified and energy is fed into the direct voltage on-board network and such that the rotor magnetic field of the rotor winding is actively reduced.

10. The motor vehicle according to claim 9, wherein the control device is configured to switch from the first operating mode to the second operating mode when a triggering condition is met, wherein meeting the triggering condition is dependent on there being an accident and/or a shutdown process of the synchronous machine.
